(19) United States
(12) Patent Application Publication
(10) Pub. No.: US 2023/0273461 A1
(43) Pub. Date: Aug. 31, 2023

(54) AUGMENTING PRE-EXISTING EYEGLASSES WITH ELECTRONIC CAPABILITIES TO TREAT ONE OR MORE OCULAR CONDITIONS

(71) Applicant: Twenty Twenty Therapeutics LLC, South San Francisco, CA (US)

(72) Inventors: Christian Gutierrez, South San Francisco, CA (US); Dimitri Azar, South San Francisco, CA (US)

(21) Appl. No.: 18/113,246

(22) Filed: Feb. 23, 2023

Related U.S. Application Data
(60) Provisional application No. 63/313,940, filed on Feb. 25, 2022.

(51) Int. Cl. G02C 9/04

(52) U.S. Cl. CPC G02C 9/04

(57) ABSTRACT

A modular system can be used with commercial eyeglasses to deliver treatment for at least one ocular condition. The modular system includes an electroactive stick-on component attachable to a portion of an eyeglass lens; and an electronic system attachable to an eyeglass frame in electrical communication with the electroactive stick-on component.

### CROSS-REFERENCE TO RELATED APPLICATIONS

This application claims the benefit of U.S. Provisional Application Serial No. 63/313,940, filed 25 Feb. 2022, entitled “SYSTEM FOR TREATMENT OF OCULAR CONDITIONS”. The entirety of this application is incorporated by reference for all purposes.

### TECHNICAL FIELD

The present disclosure relates generally to treating one or more ocular conditions and, more specifically, to a modular system, that is attachable to a patient’s pre-existing eyeglasses, that can treat one or more ocular conditions or other applications via electronic capabilities.

### BACKGROUND

Over four billion adults in the world wear eyeglasses. Eyeglasses or eyeglasses-like wearable devices can be created that have electronic capabilities for treating one or more ocular conditions or other applications. Today, however, most electronically capable eyeglasses-based devices rely on either integration of smart lenses mounted onto modified frames and/or fully custom-manufactured smart-eyeglasses, which are costly and provide users with limited options for fit, comfort, and/or style. There are no solutions today that easily retrofit and reversibly attach to a user’s existing commercial frames and lenses to provide such electronic capabilities.

### SUMMARY

The present disclosure provides a modular system that allows users to employ their existing commercial frames and lenses to employ electronic capabilities for treatment of ocular conditions or other applications. The modular system is attachable to a patient’s pre-existing eyeglasses to provide the electronic capabilities.

As such, described herein is a modular system that can be mounted to existing frames and/or lenses for treatment of ocular conditions or other applications. The modular system includes modules, including an electroactive stick-on component that can be attached to a portion of an eyeglass lens. The modular system also includes modules of an electronic system attachable to an eyeglass frame in electrical communication with the electroactive stick-on component. The electroactive stick-on component, powered by the electronic system, can deliver treatment for at least one of the ocular conditions or other applications.

Also described herein is a method for treatment of ocular conditions or other applications. The method includes applying an electroactive stick-on component to at least one lens of eyeglasses. The electroactive stick-on component is reversibly attachable to the at least one lens of the eyeglasses. The method also includes connecting an electrical connection area of the electroactive stick-on component comprising a low profile conductor to an electrical connection area comprising another low profile conductor of an electrical system attached to a frame of the eyeglasses; and treating at least one optical condition with the electroactive stick-on component powered by the electrical system.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 illustrates a modular system that can be mounted to existing frames and/or lenses for treatment of one or more ocular conditions;

FIG. 2 illustrates an example connection mechanism that can be employed between components of the modular system of FIG. 1;

FIGS. 3-5 illustrate an example of components of the modular system of FIG. 1;

FIG. 6 illustrates a method of employing existing commercial frames and lenses for treatment of one or more ocular conditions.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “eyeglasses” has a similar meaning to the terms “spectacle” and “glasses” and refers to one or more lenses mounted in a frame that holds the one or more lenses in front of a person’s eye or eyes and has at least one arm, typically two arms, that each extend over an ear of a wearer. Eyeglasses can include at least one of glasses for correcting or treating defective eyesight (e.g., nearsightedness, far-sightedness, astigmatism, or the like), sunglasses, safety glasses, and glasses used for merely aesthetic purposes.

As used herein, the term “frame” refers to a device and/or mechanism that is designed to hold the one or more lens in a proper position on a person’s head such that the one or more lens is in front of the person’s eye(s). Frames exist in a variety of styles, sizes, materials, shapes, and colors. Typically, the frame includes at least a bridge over the nose, rims around at least a portion of each of the one or more lens (typically two lenses) and holding the one or more lens to the frame, and hinged arms (or temples/temple pieces) that extend from an axial portion of the rims to temple tips that rest over the person’s ears.

As used herein, the term “lens” refers to a generally clear device (but may include tinting, in some instances) held over one or more of a person’s eyes by a frame. The lens can be, but is not limited to, a glass material, a plastic material, or the like that is substantially transparent to at least the visible light spectrum. The lens can be a prescription and/or corrective lens, a cosmetic lens, a sunglasses lens, a safety lens, or the like. For example, the lens can concentrate or disperse light rays.

As used herein, the term “ocular condition” refers to a disease, ailment, or condition that affects or involves one or more eye or one or more of the parts or regions of the eye or surrounding the eye. Non-limiting examples of ocular conditions include refractive errors, glaucoma, dry eye, myopia, presbyopia, amblyopia, cataracts, retinopathy, macular degeneration, or the like.

As used herein, the term “modular” system refers to a collection of building blocks (e.g., sub-systems, components, or the like) that can be configured in different ways and independently grouped together.

As used herein, the terms “patient” and “user” synonymously refer to one who uses the modular system and/or the eyeglasses described herein.

### II. Overview

One of the most common options for treatment of ocular conditions is through eyeglasses equipped with one or more electronic capability. Currently, electronically capable eyeglasses are complex and expensive, either employing integrated smart lenses mounted onto modified frames and/or fully custom smart-eyeglasses. These current solutions are costly and provide users with limited options for cost, fit, comfort, and/or style. Traditional eyeglasses, generally for vision correction/shading and/or aesthetic purposes, have nearly unlimited options for cost, comfort, fit, and/or style. However, such traditional eyeglasses are currently unable to treat certain types of ocular conditions, like myopia and presbyopia, for example (or to perform other applications).

Described herein is a modular system that can be mounted to existing eyeglasses (frames and lenses) allowing the existing eyeglasses to transform into eyeglasses that can treat more types of ophthalmic conditions (or to perform other applications). The modular system includes an electroactive stick-on component reversibly attachable to a portion of an eyeglass lens; and an electronic system reversibly attachable to an eyeglass frame. The electronic system can be in electrical communication with the electroactive stick-on component. The electroactive stick-on component can be configured to deliver treatment for at least one ocular condition (or to perform other applications).

### III. Systems

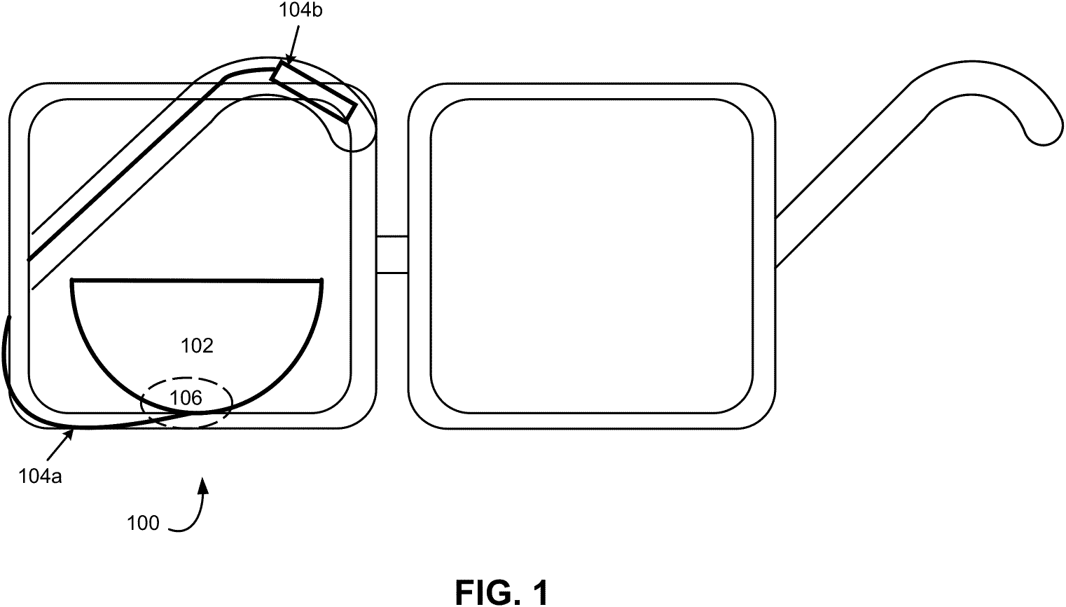

An aspect of the present disclosure can include a modular system 100 (shown in FIG. 1) that can be mounted to components of existing eyeglasses (e.g., frame and lens) to deliver treatment for at least one ocular condition (or other applications). The system 100 can be modular and include a collection of building blocks (e.g., sub-systems, components, or the like) that can be configured in different ways and independently grouped together. The modules can include at least electroactive stick-on component 102 and an electronic system 104a and 104b. The modules can make a connection with one another so establish electrical communication therebetween (an example connection 106 of shown in FIG. 1, but this connection 106 is meant to be illustrative and not limiting). Notably, one or more of the modules (e.g., the electroactive stick-on component 102 and/or at least a portion of the electronic system 104a/104b) can be placed on and/or removed from the existing glasses without damaging (or substantially damaging, a cleaning product may be required to remove remnants) the existing glasses.

As shown in FIG. 1, the modules can include an electroactive stick-on component 102, which can be reversibly affixed to a lens of the existing glasses (e.g., can be stuck to and removed from the eyeglasses one or more times). Generally, the electroactive stick-on component 102 may not substantially block or impede a user’s vision. In some instances, the electroactive stick-on component can be adhered to the lens in the user’s normal field of view and can be completely see-through/transparent. In other instances, the electroactive stick-on component 102 can be at least partially see-through/transparent. Accordingly, the electroactive stick on component 102 can be substantially constructed of one or more transparent plastics (e.g., acrylic, silicone, cyclo-olefin copolymer/polymer (COC/COP), Polymethylmethacrylate (PMMA), or the like). As an example, 90% or more of the visual field can be unobstructed. As another example, 93% or more of the visual field can be unobstructed. As a further example, 95% or more of the visual field can be unobstructed. As another example, the electroactive stick-on component 102 can be adhered to the lens in an area outside the field of view when the user is looking straight ahead. However, as still another example, the electroactive stick-on component 102 can be positioned within the patient’s field of view to cause an effect.

The electroactive stick-on component 102 can be stuck to a lens like a sticker with an adhesive material (e.g., a sticky material) or statically adhered to the lens. Optionally, the electroactive stick-on component 102 may be additionally, or alternatively, mechanically clipped onto the frame above, besides, or below the lens and/or the lens itself (e.g., with a spring-loaded clip or magnet assembly). In some instances, the adhesive material can be substantially see-through and may leave minimal residue on the glasses upon removal of the electroactive stick-on component, including one or more optical-grade pressure sensitive adhesives. In other instances, when the adhesive material and/or residue from the adhesive material is left on a lens after removal of an electroactive stick-on component 102, then the adhesive material and/or residue may be removable (e.g., by cleaning with a special chemical and/or warm water and soap).

The electroactive stick-on component 102 can be removably adhered to either side of a given lens (e.g., the front side facing the world or the back side facing the user) and can be of various sizes and/or shapes depending on the application (e.g., ocular condition being corrected and/or treated for) and/or the shape of the underlying lenses. As illustrated in FIG. 1, the electroactive stick-on component 102 has a half-moon shape, but this is only for ease of illustration and explanation, the electroactive stick-on component can be any shape. The electroactive stick-on component 102 can have any shape that fits within the lens. Additionally, the electroactive stick-on component 102 can be any size/shape required for a given application.

It should be noted that in some instances, it may be preferred that the electroactive stick-on component 102 be sized and dimensioned to take up all or substantially all of the lens. Additionally, although the electroactive stick-on component 102 is illustrated as adhered to a certain lens, this is just for illustration purposes; the electroactive stick-on component 102 can adhere to either lens of the eyeglasses or an electroactive stick-on component can be individually adhered to both lenses. Separate electroactive stick-on components 102 are necessary if their functionality is required on both lenses of the eyeglasses. Multiple electroactive stick-on components 102 can be adhered to different portions of a lens. When multiple electroactive stick-on components 102 are used each can have the same or different functions.

The modules can also include an electronic system (with a wire 104a and a components portion 104b) that can be removably attached to at least a portion of the frame of the eyeglasses and the electroactive stick on component 102. However, the two components of the electronic system (wire 104a and components portion 104b) are only drawn as positioned for ease of illustration. It should be appreciated that the electronic system (wire 104a and components portion 104b) can have any number of modular components positioned in any place on the frame of the eyeglasses.

The electronic system (wire 104a and components portion 104b) can also include control electronics and a power source. As an example, the electronic system (wire 104a and components portion 104b) can be embodied (at least in part) within a temple-tip attachment that can include one or more of a flexible substrate, an adhesive, extra power storage, additional control electronics, and additional interfaces with the electroactive stick-on component 102. In another example, the electronic system (wire 104a and components portion 104b) can be at least in part attached to the part of the frames surrounding at least one of the lenses. The attachment mechanism can be at least one of adhesive, magnetic, clip on, clip over, or the like) The electronic system (wire 104a and components portion 104b) can communicate with the electroactive stick-on component 102 to provide most of the electrical functionality to the electroactive stick-on component 102 (which can act as an end-effector). In other words, the electronic system (particularly the component portion 104b) can act as the “brains” of the electroactive stick-on component 102 by including additional control electronics that are used by the electroactive stick-on component. It should be noted that the electronic system need not be see through and may include conductive materials standard for a flex printed circuit board (PCB) (such as polyimide, Polyethylene terephthalate (PET), nylon, Liquid Crystal Polymer (LCP), or the like). The electronic system can include a components portion (shown here as 104b and described in more detail below), which can be positioned on one or more portions of the frame (e.g., a temple tip, a portion or all of the arm, the nose bridge, or the like) and a wire shown here as 104a) for interfacing with the electroactive stick-on component 102 to facilitate communication between the components portion 104b and the electroactive stick-on component 102.

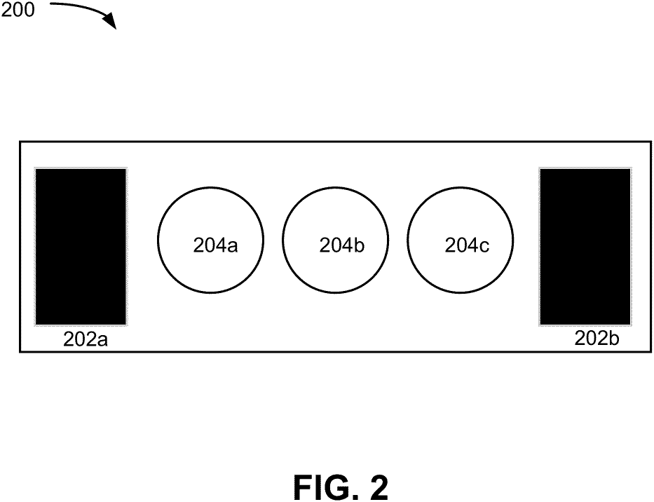

The wire 104a (e.g., made of a substantially flat, flexible mini-cable, attachable to the frame by one or more wire harness attachments) of the electronics system can interface with the electroactive stick-on component 102 through respective electrical connection areas in an attachment area 106. It should be noted that the attachment area 106 can be located at any position where the wire 104a may interface with the electroactive stick-on component 102. In some instances, the attachment area 106 interface between the wire 104a and the electroactive stick-on component 102 can be at least partially along a boundary between the lens and the frame. Each of the wire 104a and the electroactive stick-on component 102 can be equipped with a connection mechanism, such as low-profile connector 200 shown in FIG. 2, where the two connection mechanisms fit together (e.g., universal connection, male-female connection, etc.). The connection mechanisms can create a connection with one another so that the electroactive stick-on component 102 and the electronic system (wire 104a and components portion 104b) can electrically communicate therebetween. For example, the connection can occur within the attachment area 106 of FIG. 1.

As shown in FIG. 2, the low-profile connector 200 can include one or more magnets/magnetic elements (two magnetic elements 202a, 202b shown in FIG. 2) that can facilitate attachment of the electroactive stick-on component 102 and/or the electronic system (wire 104a and components portion 104b) and/or the frames at attachment area 106. The low-profile connector 200 can also include one or more electrical interconnects (three electrical interconnects 204a, 204b, and 204c are shown) to establish data transfer between the electroactive stick-on component 102 and the electronic system (wire 104a and components portion 104b). In some instances, however, this communication can be established wirelessly or at least partially wirelessly (e.g., via RF communication and/or Bluetooth, or the like). The low-profile connector 200 can also include a flexible substrate that holds at least some of the one or more magnets/magnetic elements 202a, 202b and the one or more electrical interconnects 204a-c.

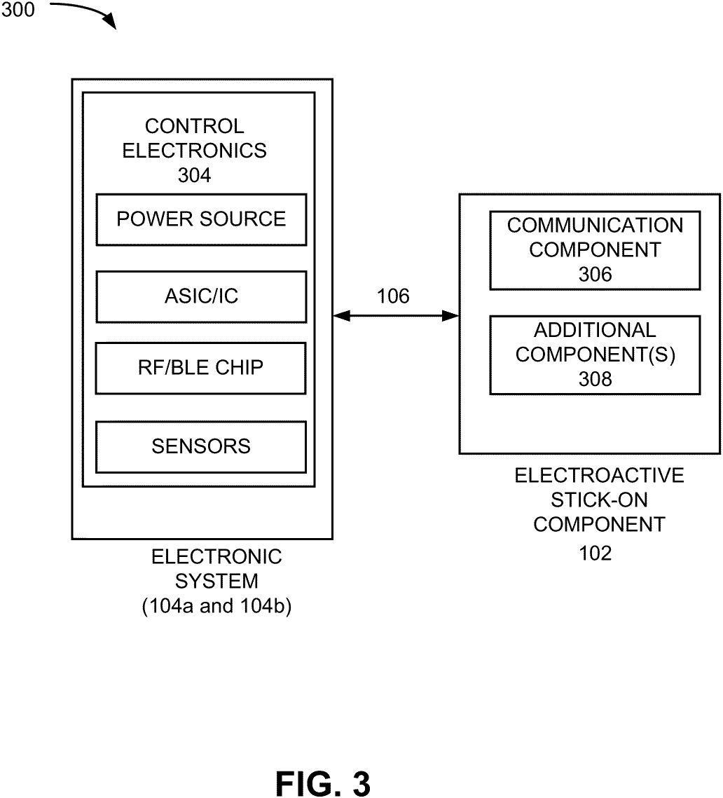

An example of the modular system 100 is shown in greater detail as system 300 in box diagram form in FIG. 3. The electroactive stick-on component 102 is attached (e.g., by a wired connection at the communication area 106) to at least a portion of the electronic system (e.g., wire 104a) that is attached to another at least a portion of the electronic system (e.g., components portion 104b). It should be noted that although illustrated as a wired connection, the attachment could alternatively be a wireless connection or a connection that is both wired and wireless. As an example, the attachment area 106 can include the low profile connector 200 of FIG. 2.

The electronic system (wire 104a and components portion 104b) can include control electronics 304 for the electroactive stick-on component 102 that can be in communication with the electroactive stick-on component to control at least a portion of the electroactive stick-on component. The control electronics 304 can be embodied in the wire 104a and/or the components portion 104b. However, in some instances, a majority of the control electronics 304 can be embedded in the components portion 104b. In other instances, the control electronics 304 can be entirely embedded in the components portion 104b (but the wire 104a may include outreaching parts of elements of the component portion, such as sensors).

The control electronics 304 can include, for example, a power source, a control chip (e.g., an ASIC or IC as illustrated), a communication chip (e.g., a radio frequency (RF) and/or Bluetooth low energy (BLE) chip as illustrated), one or more sensors, and the like. The electroactive stick-on component 102 can include an optional communication component 306 and also includes additional component(s) 308 based on the ocular condition to be treated (or the additional task to be completed). The optional communications component 306 can include a loop antenna or a Bluetooth low energy (BLE) device for bidirectional communication with the at least a portion of the control electronics 304. As an example, the loop antenna or BLE device can be located at the edge or periphery of the electroactive stick-on component 102 and need not be very thick (e.g., no more than a few hundred microns in width) in order to make most of the electroactive stick-on component 102 substantially unobstructed and transparent (as described above, at least 90%, 93%, or 95%). The additional component(s) 308 can include, but are not limited to, one or more illumination devices, such as LEDs, one or more camera, one or more photodetector, or one or more other sensors (e.g., acoustic/ultrasound, near-field/radar, EEG/EOG, or the like), which may be controlled by the electronic system. As another example, the additional component(s) can also include an electrowetting (liquid lens) capability, a liquid crystal material, a thermoresponsive material, an on-demand refraction or optical treatment (like blurring or focusing) capability, or the like.

Example treatments that can be provided by the electroactive stick-on component 102 include myopia management (e.g., transmitting violet light to an eye, changing the peripheral defocus, etc.), treatment of amblyopia (induced weaker eye), treatment of presbyopia, correction for color blindness, and the like. For example, the modular system 100 can treat myopia using LED illumination, using violet light exposure via LED illumination. The modular system 100 can also use eye sensors to detect blink, detect gaze, or to track eyes (e.g., reflective proximity sensors). The modular system 100 can treat amblyopia by optical blur, treat or detect color blindness by light modulation and color change, and/or treat presbyopia or myopic defocus with optical refraction. The modular system 100 can also treat photophobia using customized light attenuation or function as light responsive smart sunglasses.

For amblyopia treatments, such as optical blur, the electroactive stick-on component 102 can include at least one of liquid-crystal-based optics, scattering materials, low-pass spatial filtering, or the like. For treatments using LED illumination, such as treatment of myopia using violet light exposure, the electroactive stick-on component 102 can include one or more LEDs in violet light and/or blue light wavelengths. For treatments using optical refraction, such as treatment for presbyopia, myopic defocus, or the like, the electroactive stick-on component 102 can include liquid-crystal-based optics, electrowetting optics, or the like. For treatments or uses that utilize light attenuation, such as treatments for photophobia or transition lenses, the electroactive stick-on component 102 can include dichroic liquid crystal-based optics, photochromic materials, thermochromic materials, or the like. For treatments or uses that utilize eye sensors such as blink detection, gaze detection, or eye tracking, the electroactive stick-on component 102 can include IR sensors/camera, photodiode sensors, acoustic/ultrasound, near-field/radar, EEG/EOG, or the like. Light modulation-based treatments and uses, such as color changing/correction or treating color blindness or the like, the electroactive stick-on component 102 can include dichroic liquid crystal-based optics, photochromic materials, or thermochromic materials.

The modular system 100 does have some leeway in terms of positional tolerance. The electroactive stick-on component 102 can be placed anywhere necessary on the lens so long as it can communicate through communication component 306 and is positioned to correct and/or treat at least part of the ocular condition of the person wearing the eyeglasses. Communication component 306 can be designed to enable communication wherever the electroactive stick-on lens 102 is placed on the lens. In some instances, the optional additional component(s) 308 can include a light source, like an LED, to inform the person using the system 100 when the electroactive stick-on component 102 is aligned to adequately communicate with at least a portion of the eye.

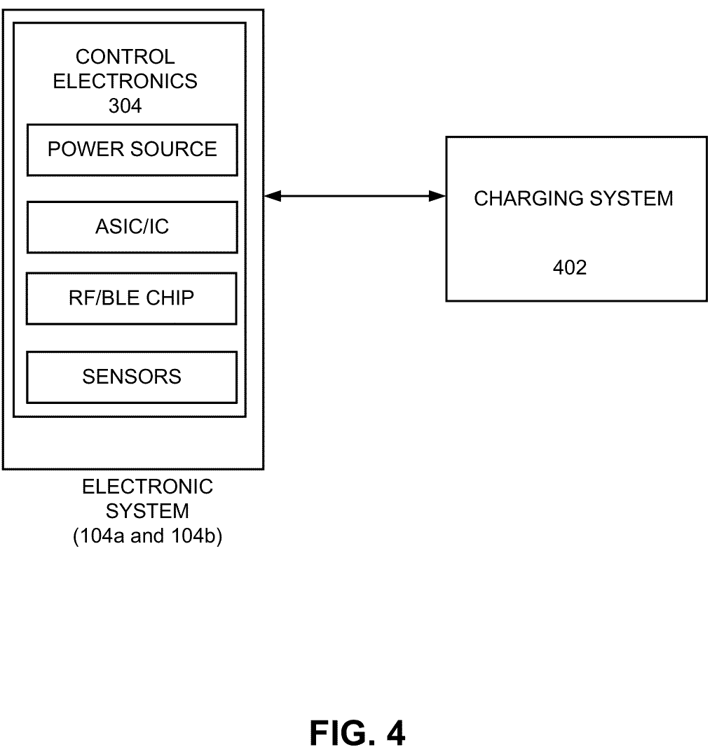

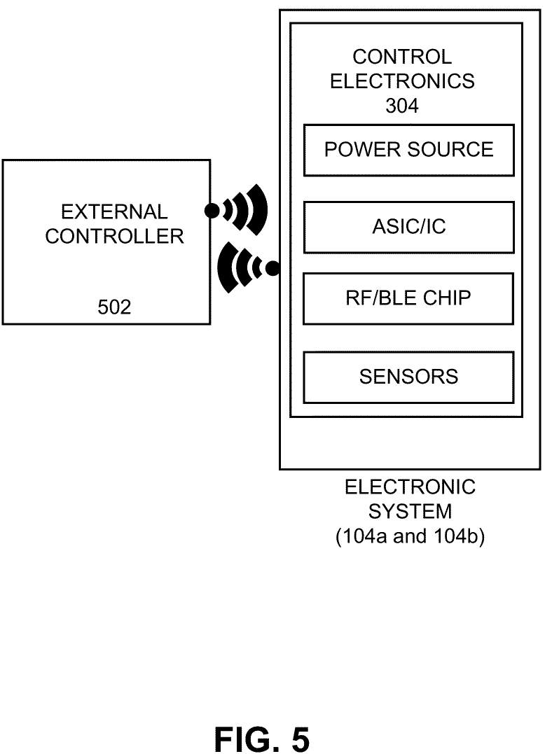

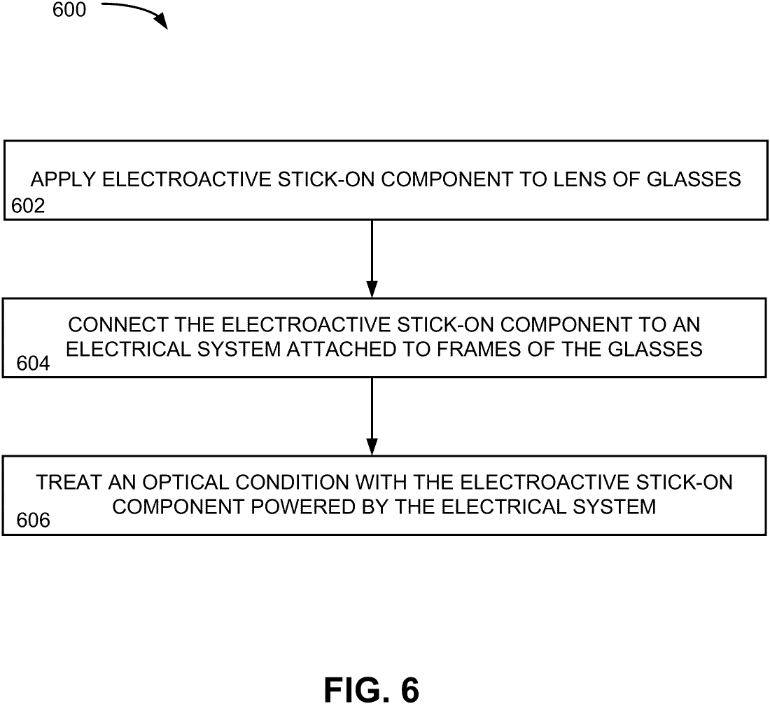

The electronic system can communicate with external devices, two examples of which are shown in FIGS. 4 and 5 (components of each can be used in connection with FIG. 3 and may be used together). As shown in FIG. 4, the electronic system can communicate (in a wired and/or a wireless manner) with a charging system 402. The charging system 402 (e.g., a battery charging system) can be within another device, such as an eyeglass case configured to house a portion of the electronic system, to recharge at least a portion of the power source. The charging system 402 can be a case containing an embedded long-life battery that can provide several charges to the power source of the electronic system. The charging system 402 can be a case that can be connected to an outlet for charging via a wired connection (such as USB-C) that can require several hours to fully charge so it can provide several charges to the power source of electronics system. As an example, at least the control electronics 304 can be placed within a glasses case with the charging system 402 and can receive either a wireless charge or a wired charge (e.g., hooked into a charging connection in the charging system 402). The charging system 402 can connect directly or through an additional wire to AC or DC power.

As shown in FIG. 5, the electronic system can communicate (in a wired and/or a wireless manner) with an external controller 502. Wireless communication is shown but is not exclusive. The external controller 502 can, for example, determine when to provide actuator functions or other functions to one or more components of the control electronics 304. As an example, the external controller 502 can be embodied in a smartphone application, so that the smartphone can provide a smart glasses platform.

As an example, if the external controller 502 were a smartphone application, the ASIC/IC of the control electronics 304 can communicate data from one or more of the sensors (e.g., time data, eye wetness data, etc.) to the external controller 502 via a radio frequency/Bluetooth low energy (RF/BLE) chip. The external controller 502 can communicate instructions to the ASIC/IC informing that the electroactive stick-on component 102 should deliver a treatment to the respective eye. The external controller 502 can keep a record of when the trigger is sent to the control electronics 304. In some instances, the external controller 502 can keep a record of additional information sent to/received from the control electronics 304. For example, the external controller 502 can receive schedule and/or prescription change information from a medical professional and update the control electronics 304 when connected.

### IV. Methods

Another aspect of the present disclosure can include a method 600 for configuring modular system 100 to treat an optical condition (or another application, although an optical condition is illustrated for simplicity). The modular system 100 can be mounted to existing eyeglasses (frames and lenses) allowing the existing eyeglasses to transform into eyeglasses that can treat more types of ophthalmic conditions (or to perform other applications). It should be understood that the modular system can include modules that include at least an electroactive stick-on component 102 that can be reversibly attachable to at least a portion of an eyeglass lens; and an electronic system (shown in FIG. 1 as wire 104a and components portion 104b) reversibly attachable to at least a portion of an eyeglass frame and able to be in electrical communication with the electroactive stick-on component 102.

At 602, the electroactive stick-on component (e.g., electroactive stick-on component 102 of FIG. 1) can be applied to a lens of glasses (it should be noted that the electroactive stick-on component can adhere to either lens of the eyeglasses on either side., either the front side facing the world or the back side facing the user). The electroactive stick-on component can be of various sizes and/or shapes depending on the application and/or the shape of the underlying lenses. The electroactive stick on component can be stuck to and removed from the eyeglasses one or more times. Generally, the electroactive stick-on component may not substantially block or impede a user’s vision. As an example, 90% or more of the visual field can be unobstructed. As another example, 93% or more of the visual field can be unobstructed. As a further example, 95% or more of the visual field can be unobstructed. As another example, the electroactive stick-on component can be adhered to the lens in an area outside the field of view.

As an example, the electroactive stick-on component can be stuck to a lens like a sticker with an adhesive material or statically adhered to the lens. Optionally, the electroactive stick-on component may be additionally, or alternatively, mechanically clipped onto the frame above the lens and/or the lens itself (e.g., with a spring-loaded clip or magnet assembly). In some instances, the adhesive material can be substantially see-through and may leave minimal residue on the glasses upon removal of the electroactive stick-on component, including one or more optical-grade pressure sensitive adhesives. In other instances, when adhesive material and/or residue is left on a lens after removal of an electroactive stick-on component, then the adhesive material and/or residue may be removable (e.g., by cleaning with a special chemical and/or warm water and soap).

At 604, the electroactive stick-on component can be connected to an electrical system (e.g., wire 104a, components portion 104b) that has been attached to the frame of glasses (as described above, the electrical system provides the brains of the electroactive stick-on component) The electronic system can include a components portion (shown here as 104b), which can be located on the frame (e.g., on one or more of a temple tip, an arm, a rim, or the nose bridge) and a wire (104a, interfacing with the electroactive stick-on component to facilitate communication between the components portion and the electroactive stick-on component). As an example, the electronic system can be embodied (at least in part) within a temple-tip attachment that can include one or more of a flexible substrate, an adhesive, extra power storage, additional control electronics, and additional interfaces with the electroactive stick-on component. The component portion of the electronic system can include control electronics and a power source. In another example, the electronic system can be at least in part attached to the rim of the frames surrounding at least a portion of one of the lenses. The electronic system can communicate with the electroactive stick-on component 102 to provide all or at least a part of the electrical functionality to the electroactive stick-on component 102 (which can act as an end-effector). It should be noted that the electronic system need not be see through and may include conductive materials standard for a flex PCB (such as polyimide, PET, nylon, LCP, or the like).

The wire (e.g., made of a substantially flat, flexible mini-cable, attachable to the frame by one or more wire harness attachments) of the electronics system can interface with the electroactive stick-on component through respective electrical connection areas in an attachment area 106 of FIG. 1 (e.g., using the connection mechanism of FIG. 2). In some instances, the interface between the wire and the electroactive stick-on component can be along an interface between the lens and the frame. Each of the wire and the electroactive stick-on component can be equipped with a connection mechanism, such low-profile connector 200 shown in FIG. 2. The connection mechanisms can create a connection with one another so that the electroactive stick-on component and the electronic system can communicate therebetween.

At 606, an optical condition can be treated with the electroactive stick-on component powered by the electrical system (or an additional user can be engaged). For example, the electrical system can cause the electroactive stick-on component (or an associated component) to perform an action (e.g., change tint or shade, change prescription strength, illuminate, or the like). The electrical system may be in communication (wired, such as through a USB or base station, or wireless) with an external controller (e.g., a mobile device, a computer, or the like) that can help to provide the optical treatment (e.g., scheduling, changes in prescription from a medical professional, or the like).

Example treatments that can be provided by the electroactive stick-on component include myopia management (e.g., transmitting violet light to an eye, changing the peripheral defocus, etc.), treatment of amblyopia (induced weaker eye), treatment of presbyopia, correction for color blindness, and the like. For example, myopia can be treated using LED illumination, using violet light exposure via LED illumination. Eye sensors can be used to detect blink, detect gaze, or to track eyes. The modular system 100 can treat amblyopia by optical blur, treat or detect color blindness by light modulation and color change, and/or treat presbyopia or myopic defocus with optical refraction. Photophobia can be treated using customized light attenuation or function as light responsive smart sunglasses.

For amblyopia treatments, such as optical blur, the electroactive stick-on component can include at least one of liquid-crystal-based optics, scattering materials, low-pass spatial filtering, or the like. For treatments using LED illumination, such as treatment of myopia using violet light exposure, the electroactive stick-on component can include one or more LEDs in violet light and/or blue light wavelengths. For treatments using optical refraction, such as treatment for presbyopia, myopic defocus, or the like, the electroactive stick-on component 102 can include liquid-crystal-based optics, electrowetting optics, or the like. For treatments or uses that utilize light attenuation, such as treatments for photophobia or transition lenses, the electroactive stick-on component can include dichroic liquid crystal-based optics, photochromic materials, thermochromic materials, or the like. For treatments or uses that utilize eye sensors such as blink detection, gaze detection, or eye tracking, the electroactive stick-on component 102 can include one or more IR sensors/camera, photodiode sensors, acoustic/ultrasound, near-field/radar, EEG/EOG, or the like. Light modulation-based treatments and uses, such as color changing/correction or treating color blindness or the like, the electroactive stick-on component can include dichroic liquid crystal-based optics, photochromic materials, or thermochromic materials.

From the above description, those skilled in the art will perceive improvements, changes, and modifications. Such improvements, changes and modifications are within the skill of one in the art and are intended to be covered by the appended claims.

The following is claimed:

1. A modular system comprising:
an electroactive stick-on component attachable to a portion of an eyeglass lens; and
an electronic system attachable to an eyeglass frame in electrical communication with the electroactive stick-on component,
wherein the electroactive stick-on component is configured to deliver treatment for at least one ocular condition.

2. The modular system of claim 1, wherein the electroactive stick-on component comprises an electrical connection area configured to interface with an electrical connection area of the electronic system.

3. The modular system of claim 2, wherein the interface between the electroactive stick-on component and the electronic system interface in the electrical connection area with a pair of low-profile conductors, each of the pair of low-profile conductors comprises at least one electrical interconnect and at least one magnet.

4. The modular system of claim 1, wherein the electroactive stick-on component is reversibly attachable to the eyeglass lens.

5. The modular system of claim 1, wherein the electronic system comprises additional control electronics for the electroactive stick-on component.

6. The modular system of claim 5, wherein the additional control electronics comprise an ASIC/IC, an RF/BLE chip, and/or a power source.

7. The modular system of claim 1, wherein the electroactive stick-on component is configured to provide electrowetting, on-demand refraction, or on-demand optical treatment.

8. The modular system of claim 1, wherein the electroactive stick-on component comprises at least one illumination device, at least one camera, and/or at least one sensor.

9. The modular system of claim 1, wherein the electronic system comprises a flat, flexible cable to connect to the electroactive stick-on component.

10. The modular system of claim 1, wherein the electronic system is configured to communicate with an external controller.

11. The modular system of claim 10, wherein the external controller is embodied in a smartphone application.

12. The modular system of claim 10, wherein the electronic system is configured to communicate with the external controller according to a wired connection of a wireless connection.

13. The modular system of claim 1, wherein the electronic system is configured to be recharged by a battery charging system.

14. The modular system of claim 13, wherein the battery charging system is configured to be on and/or within an eyeglasses case configured to house the eyeglasses.

15. The modular system of claim 1, wherein the electroactive stick-on component is at least partially transparent.

16. The modular system of claim 1, wherein the at least one optical condition comprises myopia, presbyopia, amblyopia, photophobia, dry eye or color blindness.

17. A method comprising:
applying an electroactive stick-on component to at least one lens of eyeglasses, wherein the electroactive stick-on component is reversibly attachable to the at least one lens of the eyeglasses;
connecting an electrical connection area of the electroactive stick-on component comprising a low profile conductor to an electrical connection area comprising another low profile conductor of an electrical system attached to a frame of the eyeglasses; and
treating at least one optical condition with the electroactive stick-on component powered by the electrical system.

18. The method of claim 17, wherein the treating the at least one optical condition further comprises electrowetting, on-demand refraction, or on-demand optical treatment.

19. The method of claim 17, wherein the at least one optical condition comprises myopia, presbyopia, amblyopia, photophobia, dry eye or color blindness.

20. The method of claim 17, wherein the treating further comprises receiving, by the electrical system, an instruction from an external controller to instruct the electroactive stick-on component to engage in treating the optical condition.
